(19) United States
(12) Patent Application Publication
(10) Pub. No.: US 2015/0286171 A1
(43) Pub. Date: Oct. 8, 2015

(54) IMAGE HEATING APPARATUS

(71) Applicant: CANON KABUSHIKI KAISHA, Tokyo (JP)

(72) Inventors: Takahiro Hosokawa, Kawasaki-shi (JP); Kazuhisa Kemmochi, Suntou-gun (JP); Tsutomu Miki, Komae-shi (JP); Yasuharu Notoya, Tokyo (JP); Masaru Toda, Inagi-shi (JP); Akiko Kigure, Yokosuka-shi (JP)

(21) Appl. No.: 14/674,503

(22) Filed: Mar. 31, 2015

(30) Foreign Application Priority Data
Apr. 2, 2014 (JP) 2014-076241

(51) Int. Cl. G03G 15/20

(52) U.S. Cl. CPC G03G 15/206

(57) ABSTRACT

An image heating apparatus includes: a rotatable member configured to form a nip for heating an image on a recording material, wherein the rotatable member including a fluorine-containing resin material layer at a surface thereof; a rubbing member configured to rub the surface of the rotatable member in a rubbing position; and a supplying mechanism configured to supply fluorine-containing resin material particles to the rubbing position.

### FIELD OF THE INVENTION AND RELATED ART

The present invention relates to an image heating apparatus mountable in an image forming apparatus such as an electrophotographic copying machine or an electrophotographic printer.

As a fixing device mounted in the electrophotographic copying machine or printer, a fixing device (image heating apparatus) of a contact type in which a roller or a belt is contacted to a toner image on a recording material has been employed.

In the fixing device, there is a problem that an outer peripheral surface of a fixing roller is gradually roughened by damage sustained by nipping and feeding the recording material in a nip, paper powder in the case where the recording material is paper, and a contamination with an offset toner or the like deposited on the fixing roller surface.

A most conspicuous factor changing a surface state (shape) of the fixing roller is burrs generated at end portions during cutting of the paper. In general, the cutting of the paper is made by a sharp cutter, but the burrs generate as a cutting trace. A size of the burr varies depending on a species of the paper, but a large burr is about several μm to several tens of μm in size.

FIG. 18 is a schematic view for illustrating the burr. FIG. 19 is a schematic view for illustrating paper edge damage generated on the fixing roller.

In a fixing step of heat-fixing an unfixed toner image on the recording material, when the burr or the paper is sandwiched between the fixing roller and a pressing roller in a nip, minute damage generates on the fixing roller surface. At this time, when the same-sized sheets of the paper are continuously introduced into the nip, in passing positions of end portions (edge portions) of the paper on the fixing roller, damage (paper edge damage) along a circumferential direction of the fixing roller generates (FIG. 18). As a result, at the paper edge damage portion of the fixing roller is large in degree of unevenness of the fixing roller surface compared with a portion where the paper edge damage does not generate.

Further, in the case where paper having a side wider than that of the paper continuously introduced into the nip is introduced, uneven glossiness generates on the toner image (FIG. 19). That is, unevenness of the paper edge particle on the fixing roller surface is transferred onto the toner image surface by performing the fixing step. The toner image on which the unevenness transferred is low in glossiness compared with a toner image subjected to the fixing step at a position, on the fixing roller, corresponding to a portion other than the paper edge portion. Further, on the toner image, the unevenness is continuous in a band shape in a recording material feeding direction, so that a low-glossiness portion is formed in the band shape with respect to the recording material feeding direction and is visualized as uneven glossiness (FIG. 19).

Japanese Laid-Open Patent Application (JP-A) 2012-173383 discloses a method in which damage is made less conspicuous by rubbing the fixing roller surface with respect to a rotational direction by using a rotatable abrasive member to uniformize a surface roughness. JP-A 2009-151231 discloses a technique for suppressing a lowering in image quality by rubbing the fixing roller with a rubbing (sliding) member in a direction crossing the rotational direction of the fixing roller to extend a parting layer thereby to cover deep damage.

### SUMMARY OF THE INVENTION

According to an aspect of the present invention, there is provided an image heating apparatus comprising: a rotatable member configured to form a nip for heating an image on a recording material, wherein the rotatable member including a fluorine-containing resin material layer at a surface thereof; a rubbing member configured to rub a surface of the rotatable member in a rubbing position; and a supplying mechanism configured to supply fluorine-containing resin material particles to the rubbing position.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a sectional view of a fixing device during an operation in a fixing operation mode in Embodiment 1.

FIG. 2 is a control block diagram of the fixing device.

FIG. 3 is a sectional view of the fixing device during an operation in a repairing mode.

FIG. 4 is a sectional view of a sliding device (rubbing device) and a sliding portion (rubbing portion) in the fixing device.

FIG. 5 is a sectional view of a ceramic heater of the sliding device.

FIG. 6 is a sectional view of a film of the sliding device.

FIG. 7 is a schematic view of a fixing roller and the sliding device as seen from an upstream side of a recording material feeding direction.

FIG. 8 is a schematic view for illustrating a force received by a fixing roller surface in the sliding portion.

In FIG. 9, (a) to (c) are schematic views for illustrating a repairing process of fixing roller surface layer damage by using repairing particles.

FIG. 10 is a sectional view of an image forming apparatus.

FIG. 11 is a control block diagram of a fixing device in Embodiment 2.

FIG. 12 is a schematic view for illustrating a sliding mechanism for reciprocating the sliding device.

FIG. 13 is a schematic view for illustrating a force received by a fixing roller surface in a sliding portion.

FIG. 14, (a) and (b) are schematic views for illustrating a fixing roller surface layer repairing effect by the repairing particles.

FIG. 15 is a control block diagram of a fixing device in Embodiment 3.

FIG. 16 is a sectional view of the fixing device during a repairing abrasive particle supplying operation.

FIG. 17 is a sectional view of the fixing device during a fixing roller surface layer damage repairing operation by the repairing particles.

FIG. 18 is a schematic view for illustrating a burr of paper.

FIG. 19 is a schematic view for illustrating edge portion damage.

### DESCRIPTION OF THE EMBODIMENTS

Embodiments of the present invention will be described specifically with reference to the drawings. Although the following embodiments are examples of preferred embodiments of the present invention, the present invention is not limited thereto, but constitutions thereof can also be replaced with other constitutions within the scope of the concept of the present invention.

### Embodiment 1

(1) Image forming Apparatus 10

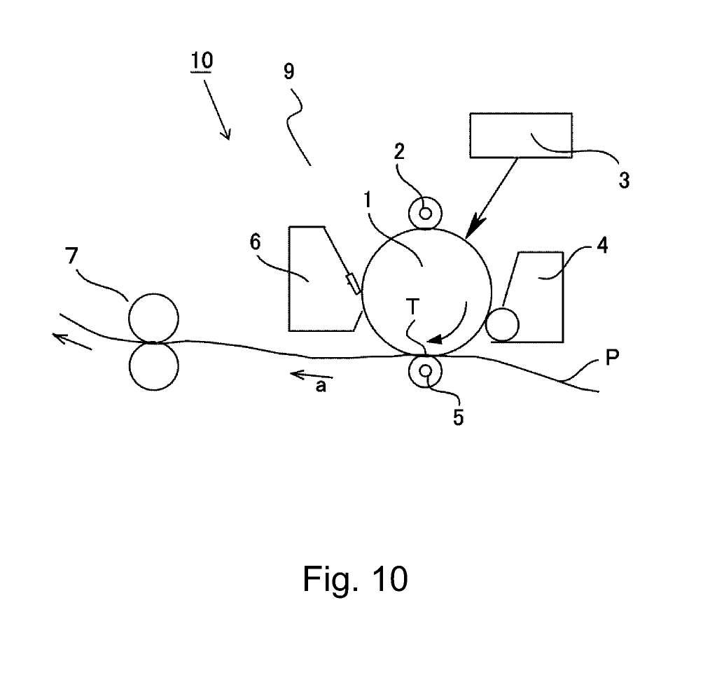

With reference to FIG. 10, an image forming apparatus 10 in which an image heating apparatus according to the present invention is mounted as a fixing device will be described. FIG. 10 is a schematic sectional view of an example of the image forming apparatus 10 (monochromatic printer in this embodiment) using electrophotographic recording technology.

In the image forming apparatus 10, an image forming portion 9 for forming a toner image on a recording material P such as plain paper, glossy paper or an OHP sheet includes a photosensitive drum 1 as an image bearing member, a charging member 2, a laser scanner 3 and a developing device 4. The image forming portion 9 further includes a cleaner 6 for cleaning the photosensitive drum 1, and a transfer member 5. An operation of the image forming portion 9 is well known and will be omitted from description.

The recording material P is fed by rotation of an unshown roller to a transfer nip T formed between the photosensitive drum 1 and the transfer roller 5. A toner image formed on an outer peripheral surface of the photosensitive drum 1 with a toner containing a parting agent is transferred onto the recording material P at the transfer nip T. The recording material P carrying thereon the (unfixed) toner image transferred thereon is sent to a fixing device (fixing portion) 7, and then the toner image is heat-fixed on the recording material P by the fixing device 7. The recording material P coming out of the fixing device 7 is discharged on a tray by rotation of an unshown roller.

### (2) Fixing Device 7

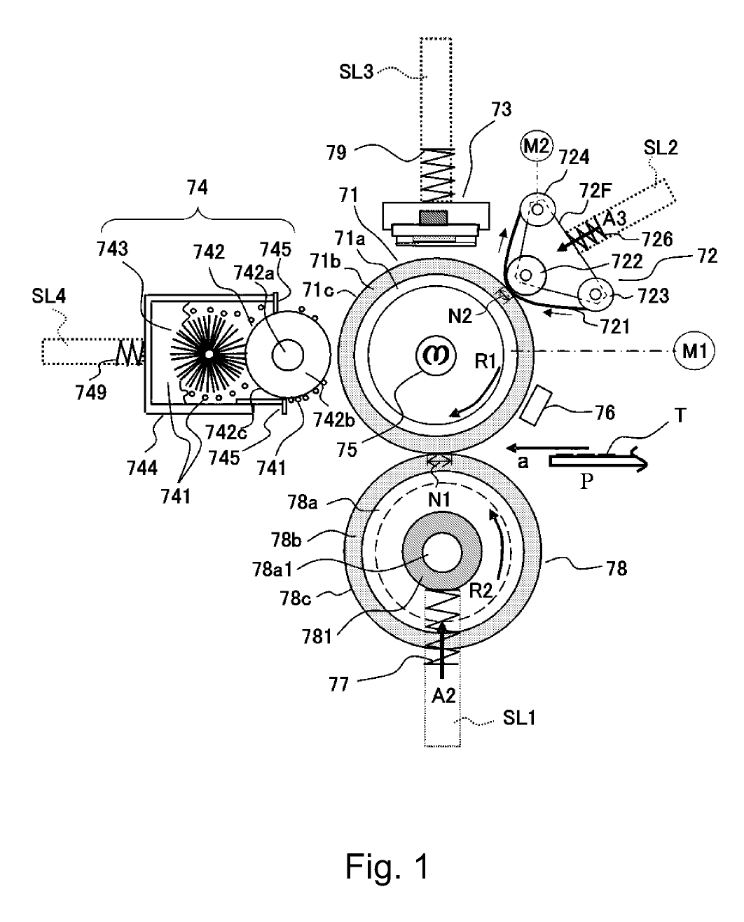

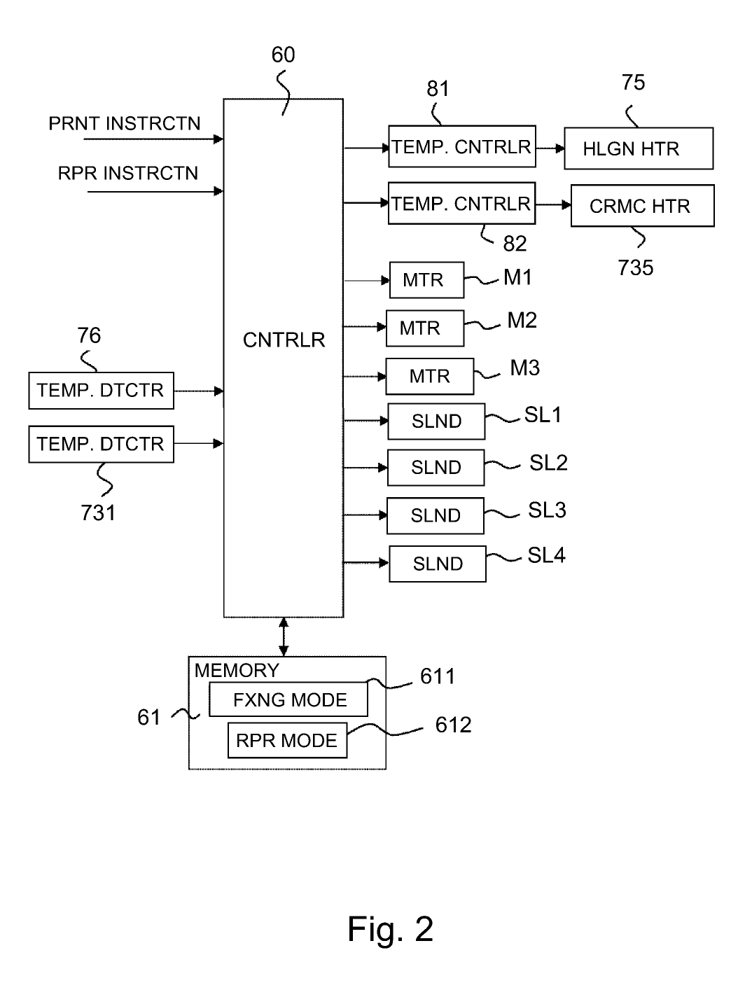

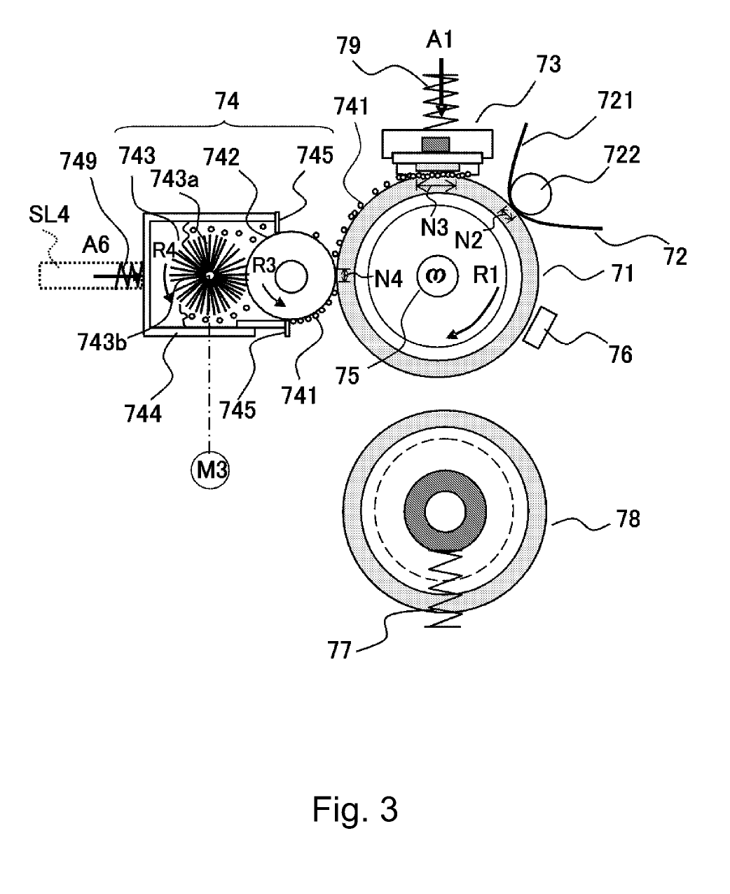

FIG. 1 is a schematic sectional view of the fixing device 7 in this embodiment during an operation in a fixing mode. FIG. 2 is a control block diagram of the fixing device 7. FIG. 3 is a schematic sectional view of the fixing device 7 during an operation in a repairing mode. The fixing device 7 in this embodiment is a device of an oil-less fixing type in which no oil is applied onto an outer peripheral surface of a fixing roller 71.

The fixing device 7 includes the fixing roller 71 and a pressing roller 78 which are rotatable members for forming a nip N. The fixing device 7 further includes a cleaning device 72, a sliding device 73, a repairing particle supplying device (supplying mechanism) 74, a halogen heater (heating source) 75 and a temperature detecting element 76.

Further, the fixing device 7 performs an operation in a repairing mode in addition to an operation in a fixing operation mode. In a memory 51 such as RAM or ROM, a fixing operation mode 611 and a repairing mode 612 are stored. A controller 60 consisting of CPU executes the operation in the fixing operation mode 611 when a print instruction (command) is inputted, and executes the operation in the repairing mode 612 when a repairing instruction (command) is inputted.

In the operation in the fixing operation mode 611, a heat-fixing operation for fixing the (unfixed) toner image T, carried on the recording material P, on the recording material P is performed. In the operation in the repairing mode 612, a repairing for repairing damage (surface layer damage) generated on the surface of the fixing roller 71 is performed.

The fixing roller 71 includes an aluminum hollow core metal 71a of about 68 mm in outer diameter, an elastic layer 71b formed on the core metal 71a, and a parting layer 71c formed on the elastic layer 71b. An outer diameter of the fixing roller 71 is 70 mm.

The elastic layer 71b is formed by molding a silicone rubber of 20° in rubber hardness (measured as JIS-A hardness under a load of 1 kg) in a thickness of 1.0 mm. The parting layer 71c is formed by coating the elastic layer 71b with a 50 μm-thick fluorine-containing resin material tube (fluorine-containing resin material layer). The fluorine-containing resin material tube is constituted by PFA (tetrafluoroethylene-perfluoroalkylvinyl ether copolymer). The fixing roller 71 is rotatably held by a frame (not shown) of the fixing device 7 via bearings at end portions (not shown) of the core metal 71a.

The halogen heat 75 disposed inside the core metal 71a of the fixing roller 71 is held at end portions thereof by the frame described above.

The pressing roller 78 includes an aluminum hollow core metal 78a of about 48 mm in outer diameter, an elastic layer 78b formed on the core metal 78a, and a parting layer 78c formed on the elastic layer 78b. An outer diameter of the fixing roller 78 is 50 mm. In FIG. 1, for convenience, the fixing roller 71 and the pressing roller 78 are illustrated in the same outer diameter.

The elastic layer 78b is formed by molding a silicone rubber of 20° in rubber hardness (measured as JIS-A hardness under a load of 1 kg) in a thickness of 1.0 mm. The parting layer 78c is formed by coating the elastic layer 78b with a 100 μm-thick fluorine-containing resin material tube (fluorine-containing resin material layer). The fluorine-containing resin material tube is constituted by PFA.

The pressing roller 78 is held movably in a radial direction of the fixing roller 71 in a state in which end portions 78a1 of the core metal 78a are supported by the above-described frame via bearings 781. Each bearing 781 is pressed by a pressing spring 77 in a direction (arrow A2 direction in FIG. 1) in which the bearing 781 approaches the fixing roller 71, so that the surface of the pressing roller 78 is contacted to the surface of the fixing roller 71 and thus a nip N1 (FIG. 1) having a predetermined width is formed by the pressing roller surface and the fixing roller surface.

In this embodiment, the nip N1 having a width of about 7 mm is formed by the pressing roller surface and the fixing roller surface by pressing the pressing roller 78 against the fixing roller 71 with a pressure of 784 N (80 kgf).

The cleaning device 72 includes a fibrous cleaning web 721, an elastic roller 722, a supplying roller 723, a winding-up roller 724 and a frame 72F for rotatably holding these rollers. The cleaning web 721 is wound around the supplying roller 723, and is wound up by the winding-up roller 724 via the elastic roller 722.

The frame 72F is held movably in the radial direction of the fixing roller 71 by the above-described frame, and is pressed by a pressing spring 726 in a direction (arrow A3 direction in FIG. 1) in which the frame 72F approaches the fixing roller 71. By this pressure (urging force) of the pressing spring 726, the surface of the cleaning web 721 is contacted to the surface of the fixing roller 71 by the elastic roller 722, so that a cleaning portion N2 (FIG. 1) having a predetermined width is formed by the cleaning web surface and the fixing roller surface.

### (3) Fixing Operation Mode 611

With reference to FIGS. 1 and 2, the operation in the fixing operation mode 611 will be described. The controller 60 drives a motor M1, so that the fixing roller 71 is rotated in an arrow R1 direction. A rotational speed of the fixing roller 71 is set so that a surface moving speed of the fixing roller 71 is 230 mm/sec. By rotation of the fixing roller 71, the pressing roller 78 is rotated in an arrow R2 direction while following the rotation of the roller 71.

Then, between the nip N1 and the cleaning portion N2, a detection temperature of the fixing roller surface monitored by a temperature detecting element 76 such as a thermistor disposed in non-contact with the fixing roller surface is obtained. Then, on the basis of the detection temperature, a first temperature control circuit 81 is driven, so that electric power supplied from a power source (not shown) to the halogen heater 75 is controlled. As a result, a state temperature of the fixing roller 71 is maintained at a predetermined fixing temperature (target temperature). In this embodiment, setting is made so that the fixing temperature is 180° C.

Next, a motor M2 is driven, so that the winding-up roller 724 is rotated. By rotation of the winding-up roller 724, the cleaning web 721 is pulled out from the supplying roller 723 in a direction opposite to the rotational direction of the fixing roller 71, and then is wound up by the winding-up roller 724 while being pressed against the fixing roller surface by the elastic roller 722.

The recording material P carrying thereon the (unfixed) toner image T is heated by the surface of the fixing roller 71 and the surface of the pressing roller 78 while being nipped and fed through the nip N1, so that the toner image T is heat-fixed on the recording material P. In the nip N1, a foreign matter, such as paper powder of the recording material P or an offset toner, deposited on the surface of the fixing roller 71 is removed by the cleaning web 721 at the cleaning portion N2.

### (4) Repairing Particle Supplying Device 74

The repairing particle supplying device (supplying mechanism) 74 for supplying, to a rubbing (sliding) PN3 (FIG. 3) via the fixing roller 71, repairing particles (fluorine-containing resin material particles) 741 for repairing the damage generated on the surface of the fixing roller 71 will be described. As shown in FIG. 1, the repairing particle supplying device 74 includes the repairing particles 741, a repairing particle supplying roller (repairing member or supplying member) 742, a stirring brush roller 743, an accommodating container 744 and a blade (regulating member) 745.

The repairing particles 741 are accommodated in the accommodating container 744. The stirring brush roller 743 disposed inside the accommodating container 744 is held rotatably by the accommodating container 744 at end portions of a core metal 743b (FIG. 3) described later with respect to a direction perpendicular to the feeding direction a. The repairing particle supplying roller 742 disposed so as to range from the inside to the outside of the accommodating container 744 is rotatably held by the accommodating container 744 at end portions of a core metal 742a (FIG. 1) described later with respect to the direction perpendicular to the feeding direction a.

In the supplying device 74, the accommodating container 744 is held by the above-described frame so as to be movable in the radial direction of the fixing roller 71, so that the accommodating container 744 is pressed by a pressing spring 49 in a direction (arrow A6 direction in FIG. 13) in which the accommodating container 744 approaches the fixing roller 71 during the operation in the repairing mode. As a result, the surface of the supplying roller 742 is contacted to the surface of the fixing roller 71, so that a supplying portion N4 (FIG. 3) having a predetermined width is formed between the supplying roller surface and the fixing roller surface.

Further, the supplying device 74 is moved in a direction (opposite to the arrow A6 direction) in which the accommodating container 74 is spaced from the surface of the fixing roller 71 against pressure of the pressing spring 749 by a plunger (not shown) of a solenoid SL4 driven by the controller 60 during the operation in the fixing operation mode. As a result, the supplying roller 742 is spaced from the fixing roller 71 (FIG. 1).

With reference to FIG. 13, a supplying operation of the repairing particles 741 by the supplying device 74 during the operation in the repairing mode will be described. A motor M3 is driven by the controller 60, so that the brush roller 743 is rotated in an arrow R4 direction at the surface moving speed of 100 mm/sec. By the brush roller 743, the repairing particles 741 in the accommodating container 742 are supplied to the surface of the supplying roller 742. Thereafter, the supplying roller 742 is rotated in an arrow R5 direction while following the rotation of the fixing roller 71, whereby the repairing particles 741 on the supplying roller surface are supplied to the surface of the fixing roller 71.

In this embodiment, the fixing roller 71 is rotated at the surface moving speed of 230 mm/sec, and therefore also the supplying roller 742 is rotated at the same surface moving speed. A fur brush 743a, described later, of the brush roller 743 is rotated in the arrow A4 direction at the surface moving speed of 100 mm/sec in contact with the surface of the supplying roller 742, so that the repairing particles 741 are supplied to the surface of the supplying roller 742. Thereafter, the supplying roller 742 is rotated in the arrow R3 direction while following the rotation of the fixing roller 71, so that the repairing particles 741 are supplied to the surface of the fixing roller 71 via the supplying portion N4.

The supplying roller 742 is constituted by the following members. As shown in FIG. 1, basically, an outer peripheral surface of a core metal 742a formed of metal such as SUS or aluminum in a round shaft shape is subjected to a surface roughening process such as blasting, and thereafter an elastic layer 742b is formed thereon. The core metal 742a is rotatably held by the accommodating container 744 via bearings at end portions thereof with respect to the direction perpendicular to the feeding direction a.

When a thermal capacity or a thermal conductivity of the elastic layer 742b is large, heat received from the surface of the fixing roller 71 is absorbed into an inside of the supplying roller 742, so that the temperature of the fixing roller 71 is lowered. For that reason, as the material for the elastic layer 742b, it is desirable that a material which has a low thermal capacity and a low thermal conductivity to the possible extent and which has a high heat-insulation effect is used. As an example of the high heat-insulative material used for the elastic layer 742b, a sponge rubber formed with a silicone rubber foam or a bubble from obtained by dispersing a hollow filler in the silicone rubber may suitably be used.

Further, with respect to an outer diameter of the supplying roller 742, when the outer diameter is smaller, the thermal capacity can be suppressed to a smaller value, so that heat of the fixing roller 71 does not readily dissipate, but when the outer diameter is excessively small, a width of the supplying portion N4 narrows. Then, due to insufficient contact between the surface of the supplying roller 742 and the surface of the fixing roller 71, the repairing particles 741 are not readily supplied from the supplying roller 742 to the fixing roller 71, and therefore a proper diameter is required. Also with respect to a thickness of the elastic layer 742b, when the elastic layer 742b is excessively thin, heat is liable to dissipate into the core metal 742a, and therefore a proper thickness is needed.

In view of the above factors, in this embodiment, the elastic layer 742b was formed using a 2 mm-thick sponge-like silicone rubber from, and on the outer peripheral surface of this elastic layer, a PFA layer was formed as a parting layer 742c. The outer diameter of the supplying roller 742 was 30 mm.

As a material for the parting layer 742c, a 50 μm-thick PFA tube excellent in durability was used. As the material for the parting layer 742c, other than PFA, a fluorine-containing resin material such as polytetrafluoroethylene (PTFE) or tetrafluoroethylene-hexafluoropropylene copolymer (FEP) may also be used. Alternatively, the parting layer 742c may also be formed by subjecting the outer peripheral surface of the elastic layer 742b to GLS latex coating.

When a surface hardness of the supplying roller 742 is low, even at low pressure, it is possible to obtain the supplying portion N4 having a predetermined width. However, when the surface hardness of the supplying roller 742 is excessively low, a degree of durability of the supplying roller 742 is lowered. Therefore, in this embodiment, the surface hardness of the supplying roller 742 was 40-45 as Asker-C hardness (load: 4.9 N).

The surface of the supplying roller 742 is pressed against the surface of the fixing roller 71 at a pressure of 39.2 N (maximum) (4 kgf (maximum)), so that the supplying portion N4 having a predetermined width is formed. By controlling the pressure (contact pressure) of the surface of the supplying roller 742 with the surface of the fixing roller 71, a supply amount of the repairing particles 741 to the fixing roller 71 can be arbitrarily adjusted.

The brush roller 743 contacts the supplying roller surface over the entirety of the supplying roller 742 with respect to the direction perpendicular to the feeding direction a. The brush roller 743 rotates in an arrow R4 direction in FIG. 13, so that the repairing particles 741 are supplied onto the surface of the supplying roller 742.

The brush roller 743 is prepared by winding and fixing the fur brush 743a (FIG. 3), formed in a pile shape by fastening fibers to a base cloth, about a core metal 743b. A fiber density of the fur brush 743a is about 500 fibers/mm² in terms of a fastening density on the base cloth, and a fiber length (free length) of the fur brush 743a is 3 mm.

The blade 745 has not only a function of regulating the repairing particles 741 supplied to the surface of the supplying roller 742 but also a function of preventing leakage of the repairing particles 741 in the accommodating container 744. The blade 745 is fixedly disposed on the accommodating container 744 so as to lightly contact the surface of the supplying roller 742.

The repairing particles 741 stored in the accommodating container 744 are held in an accommodated state in a space, inside the accommodating container 744, which is substantially hermetically sealed by being surrounded by the accommodating container 744, the blades 745 and the supplying roller 742, so that the leakage-out of the abrasive particles 741 to the outside of the accommodating container 744 is prevented.

### (5) Sliding Device 73

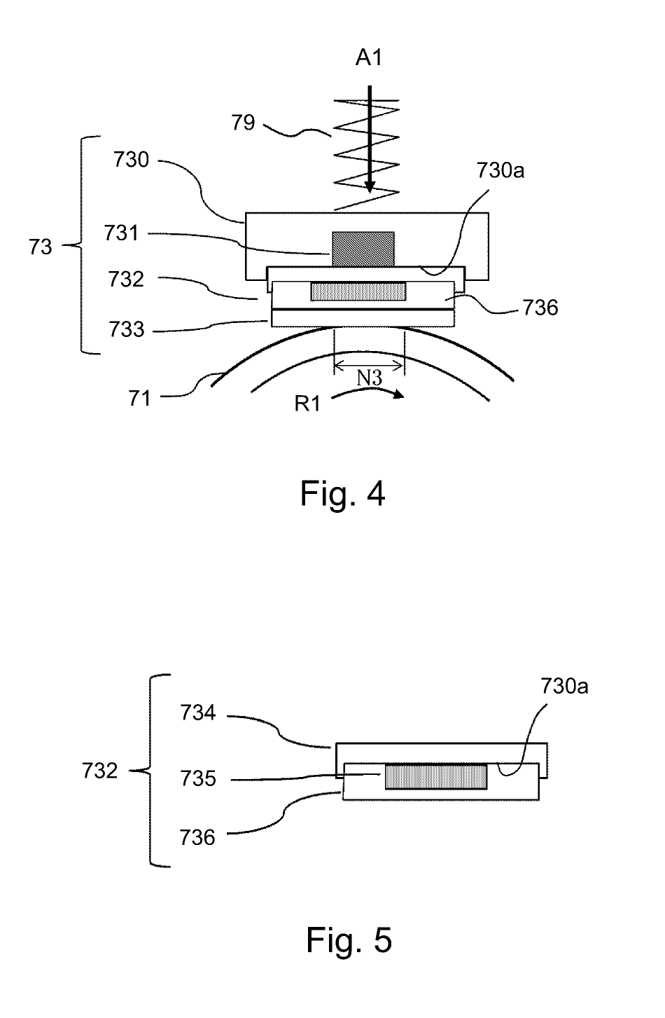

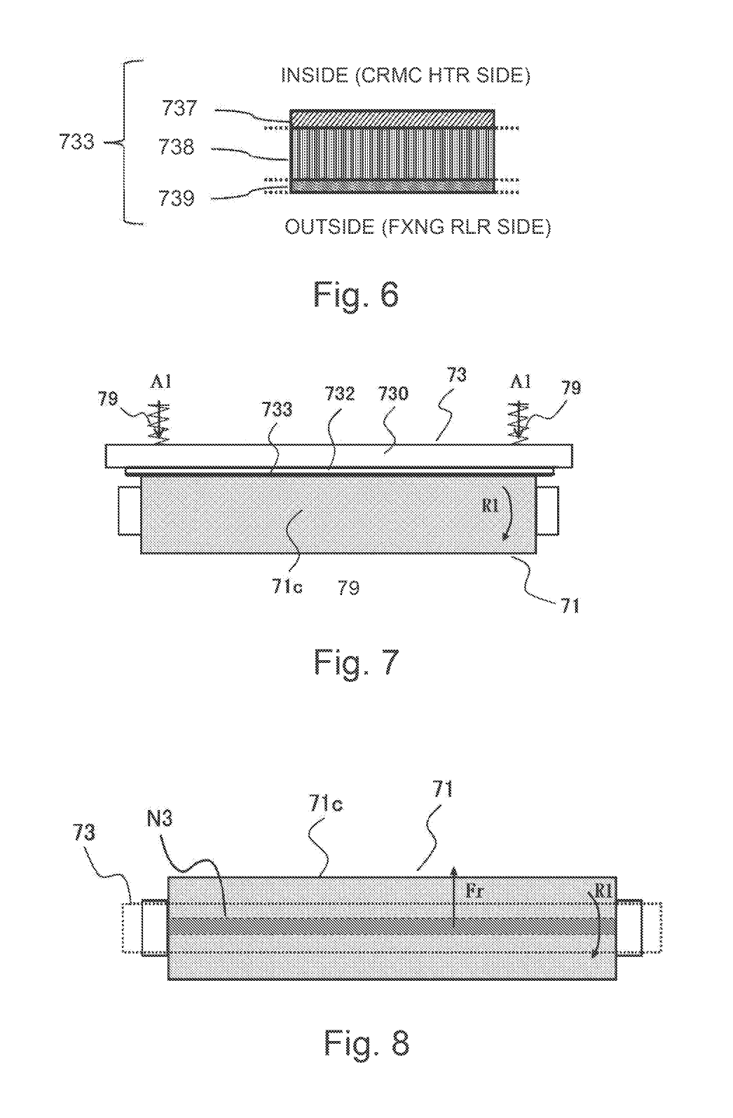

A sliding device 73 for forming the sliding (rubbing) position N3 with the surface of the fixing roller will be described. FIG. 4 is a sectional view of the sliding device 73. FIG. 5 is a sectional view of a ceramic heater 732 for the sliding device 73. FIG. 6 is a sectional view of a film 733 of the fixing device 73.

As shown in FIG. 4, the sliding device 73 includes a heater holder 730, a temperature detecting element 731, the ceramic heater (heating source) 732, and a film (sliding member) 733. The ceramic heater 732 is held on the surface of the heater holder 730 in the fixing roller 71 side, and the film 733 is bonded to the surface of the ceramic heater 732 in the fixing roller side.

The spaced 73 is held by the above-described frame, with respect to a direction perpendicular to a feeding direction a, movably in the radial direction of the fixing roller 71 at end portions of the holder 730, so that the holder 730 is pressed by a pressing spring 79 in a direction (arrow Al direction in FIG. 3) in which the holder 730 approaches the fixing roller 71 during the operation in the repairing mode. As a result, the surface of the film 733 is contacted to the surface of the fixing roller 71, so that the sliding position N3 (FIG. 3) having a predetermined width is formed between the film surface and the fixing roller surface.

Further, the sliding device 73 is moved in a direction (opposite to the arrow Al direction) in which the holder 730 is spaced from the surface of the fixing roller 71 against pressure of the pressing spring 79 by a plunger (not shown) of a solenoid SL3 driven by the controller 60 during the operation in the fixing operation mode. As a result, the film 733 is spaced from the fixing roller 71 (FIG. 1).

The ceramic heater 732 is held by a recessed portion 730a (FIG. 4) formed on the surface of the holder 730 in the fixing roller 71 side with respect to a direction perpendicular to the feeding direction a. The ceramic heater 732 includes an elongated substrate 734 (FIG. 5). On the surface of the substrate 734 in the fixing roller 71 side, a heat generating resistor 735 is formed along the direction perpendicular to the feeding direction a in the fixing roller 71 side, and a protective layer 736 is formed so as to cover the heat generating resistor 735. The substrate 734 is an insulative ceramics substrate of alumina, aluminum nitride or the like or a heat-resistant resin substrate of polyimide, PPS, a liquid polymer or the like. The heat generating resistor 735 is prepared by subjecting a paste of a material, such as Ag/Pd (silver/palladium), RuO₂ or Ta₂N, to screen printing and then by baking the paste. The heat generating resistor 735 has a linear shape of about 10 mm in thickness, about 1-5 mm in width and about 300 mm in length. The protective layer 736 is formed of glass in a thickness of 50 μm.

The holder 730 is formed of a heat-resistant resin material, such as the liquid crystal polymer, phenolic resin, PPS or PEEK. With a lower thermal conductivity of the holder 730, a heat efficiency with respect to heating of the surface of the fixing roller 71 becomes higher, and therefore it is desirable that a material having a low thermal conductivity is used as material for the holder 730.

On a back surface, of the ceramic heater 732, opposite from the fixing roller 71, a temperature detecting element 731 (FIG. 4) such as a thermistor is provided for the purpose of temperature-controlling the ceramic heater 732 or for the purpose of monitoring abnormal temperature rise of the ceramic heater 732.

With respect to the feeding direction a of the recording material P, the film 733 is formed in the substantially same width as that of the ceramic heater 732, and the film 733 is bonded onto a protective layer 736 for the ceramic heater 732 (FIG. 4). As shown in FIG. 6, the film 733 includes a base layer 737 in an inner surface side thereof, an elastic layer 738 formed on the base layer 737, and a sliding layer 739 formed, in an outer surface side thereof, on the elastic layer 738. The sliding layer 739 is provided for decreasing a frictional force generated due to friction (sliding) with the surface of the fixing roller 71. As a material for the sliding layer 739, other than PAF excellent in sliding property, a fluorine-containing resin material such as polytetrafluoroethylene (PTFE) or tetrafluoroethylene-hexafluoropropylene copolymer (FEP) may be used. Further, a thickness of the sliding 738 may preferably be about 100-300 μm.

The base layer 737 is provided for preventing breakage of the film 733 due to dynamic frictional force between the surface of the film 733 and the surface of the fixing roller 71 at the sliding position N3. As a material for the base layer 737, an electro-formed metal such as nickel or SUS (stainless steel) or a heat-resistant resin material such as polyimide. A thickness of the base layer 737 may preferably be about 50-150 μm.

The elastic layer 738 is provided for improving a contact property between the film 733 and a recessed damage generated on the surface of the fixing roller 71. As a material for the elastic layer 738, a silicone rubber may preferably be used. A thickness of the elastic layer 738 may preferably be about 50-500 μm.

In this embodiment, as the film 733, a film which includes the base layer 737 consisting of a 75 μm-thick nickel layer and which is prepared by coating surface of the base layer with a 300 μm-thick silicone rubber L as the elastic layer 738 and then by coating the elastic layer 738 with a 200 μm-thick PFA layer as the sliding layer 739 is used.

### (6) Repairing Mode 612

As shown in FIG. 3, in an operation in the repairing mode, first, the fixing roller 71 and the pressing roller 78 are spaced so that a foreign matter deposited on the surface of the pressing roller 78 is not deposited on the fixing roller 71. In that state, the foreign matter deposited on the fixing roller surface is removed by the cleaning web 721 of the cleaning device 72 by rotating the fixing roller 71.

Thereafter, the supplying roller 742 of the supplying device 74 is contacted to the fixing roller 71 to form the supplying portion N4, and the film 733 of the sliding device 73 is contacted to the fixing roller 71 to form the sliding position N3. Then, the repairing particles 741 are supplied from the supplying device 74 to the surface of the fixing roller 71 via the supplying portion N4, and then, the repairing particles 741 are welded on the surface of the fixing roller 71 at the sliding position N3 to repair the damage of the surface of the fixing roller 71.

Also in the operation in the repairing mode, setting is made so that the surface moving speed of the fixing roller 71 is 230 mm/sec and the surface temperature of the fixing roller 71 is 180° C.

With reference to FIGS. 1, 2 and 3, the operation in the repairing mode will be specifically described. When a solenoid SL1 is driven (turned on) by the controller 60, the solenoid SL1 moves the bearing 781 of the pressing roller 78 by a plunger (not shown) in a direction opposite to an arrow A2 direction in FIG. 1 against pressure of the pressing spring 77. As a result, the pressing roller 78 is spaced from the fixing roller 71 (FIG. 3).

Further, when the motor M1 is driven, the fixing roller 71 is rotated in the arrow R1 direction at the surface moving speed of 230 mm/sec by the drive of the motor M1. Then, when the motor M2 is driven, the winding-up roller 724 of the cleaning device 72 is rotated by the drive of the motor M2. As a result, the cleaning web 721 is pulled out from the supplying roller 723, so that the foreign matter, such as the paper powder or the offset toner, deposited on the surface of the fixing roller 71 at the cleaning portion N2.

Further, when the solenoid SL3 is driven (turned off), the holder 730 of the sliding device 73 is pressed in the direction (arrow A1 direction in FIG. 3) in which the holder 730 approaches the fixing roller 71. As a result, the surface of the film 733 contacts the surface of the fixing roller 71, so that the sliding position N3 is formed by the film surface and the fixing roller surface. In this embodiment, the sliding position N3 having the width of about 3 mm is formed by pressing the holder 730 with a force of 39.2 N (4 kgf) by the pressing spring 79.

Further, when the motor M3 is driven, the brush roller 743 is rotated in the arrow R4 direction at the surface moving speed of 100 mm/sec by the drive of the motor M3. By the rotation of the brush roller 743, the repairing particles 741 in the accommodating container 744 are supplied to the surface of the supplying roller 742. As a result, the repairing particles 741 are uniformly deposited on the surface of the supplying roller 742, and the supplying roller 742 holds the repairing particles 741.

Further, when the solenoid SL4 is driven (turned off), the accommodating container 744 of the supplying device 74 is pressed in a direction (arrow A6 direction in FIG. 3) in which the accommodating container 744 approaches the fixing roller 71 by the pressing spring 749. As a result, the surface of the supplying roller 742 is contacted to the surface of the fixing roller 71, so that the supplying portion N4 is formed by the supplying roller surface and the fixing roller surface. The supplying roller 742 is rotated in the arrow R3 direction by following the rotation of the fixing roller 71, so that the repairing particles 741 on the surface of the supplying roller 742 are supplied to the surface of the fixing roller 71 via the supplying portion N4.

The repairing particles 741 supplied to the surface of the fixing roller 71 are fed to the sliding position N3 by the rotation of the fixing roller 71, and are accumulated at the sliding portion between the surface of the film 733 and the surface of the fixing roller 71.

Next, the controller 60 obtains the temperature detected by the temperature detecting element 76, and controls electric power supplied from a power source (not shown) to the halogen heater 75 by driving the first temperature control circuit 81 on the basis of the detection temperature. Further, the controller 60 obtains the detection temperature from the temperature detecting element 731, and controls electric power supplied from the power source to the heat generating resistor 735 of the ceramic heater 732 by driving the second temperature control circuit 82 on the basis of the detection temperature.

In this embodiment, the electric power supplied to the halogen heater 75 and the ceramic heater 732 so that the surface temperature of the fixing roller 71 is 180° C.

The repairing particles 741 accumulated in the sliding position N3 is melted by being subjected to heat of the fixing roller 71 heated by the halogen heater 75 and heat of the film 733 heated by the ceramic heater 732 and further by being subjected to pressure in the sliding position N3, so that the abrasion powder 71c1 is melted on the surface of the fixing roller 71. As a result, the damage on the surface of the fixing roller 71 is repaired.

### (7) Characteristic of Repairing Particles 741

The repairing particles 741 are melted on the parting layer 71c (surface layer) of the fixing roller 71, and therefore it is desired that the repairing 741 have the same physical property as that of the surface layer of the fixing roller 71. In an oil-less fixing type, as the material for the surface layer of the fixing roller 71, the fluorine-containing resin material excellent in parting property from the toner on the recording material P is used, and therefore also the repairing particles 741 use the fluorine-containing resin material as the material therefor.

As the fluorine-containing resin material for the repairing particles 741, it is possible to use PFA, PTFE, FEP, or the like. It is also possible to use polychlorofluoroethylene (PCTFE), ethylene-tetrafluoroethylene copolymer (ETFE), polyvinylidene fluoride (PVDF), amorphous (FRM), or the like. Of these fluorine-containing resin materials, PFA which is easily deformed particularly at a temperature of a glass transition point or more may preferably be used.

When a melting point of the repairing particles 741 is lower than the surface temperature of the fixing roller 71 during repairing of the damage (surface layer damage) generated on the surface of the fixing roller 71, the following problem occurs. That is, in a repairing step of the surface layer damage, the repairing particles 741 are welded on the supplying roller 742 by the heat of the fixing roller 71, and therefore the repairing particles 741 cannot be stably supplied to the surface of the fixing roller 71. Also in a fixing step, when the melting point of the repairing particles 741 is lower than the surface temperature of the fixing roller 71, the repairing particles 741 welded on the surface of the fixing roller 71 are melted and peeled off from the surface of the fixing roller 71.

For that reason, the melting point of the repairing particles 741 is required to be made higher than the surface temperature of the fixing roller 71 during the repairing and during the fixing.

Further, in the case where the melting point of the repairing particles 741 is higher than the melting point of the surface layer member by 50° C. or more, in the repairing step, the repairing particles 741 are not readily welded on the surface layer of the fixing roller 71, so that it becomes difficult to repair the surface layer damage of the fixing roller 71.

From the above, in this embodiment, the surface temperature of the fixing roller 71 during the repairing and during the fixing is 180° C., and the melting point of the surface layer member (PFA) of the fixing roller 71 is 310° C., and therefore the melting point of the repairing particles 741 in this embodiment is required to be in the range of 180° C. to 360° C.

When the particle size of the repairing particles 741 is excessively large, in the repairing process, the repairing particles 741 are welded on the surface of the fixing roller 71, so that the thickness of the surface layer of the fixing roller 71 largely increases. As a result, in the fixing roller 71 in which the heat is transferred between the elastic layer 71b and the surface of the parting layer 71c, a fixing property becomes more disadvantageous with a larger thickness of the parting layer 71c on the elastic layer 71b.

On the other hand, when the particle size of the repairing particles 741 is excessively small, a cohesive force of the repairing particles 741 increases, and flowability is lowered, and therefore the repairing particles 741 cannot be stably supplied to the surface of the fixing roller 71. From the above, the particle size of the repairing particles 741 may preferably be about 0.1-10 μm.

In this embodiment, as the surface layer of the fixing roller 71, the PFA tube having the melting point of 310° C. is used, and therefore also as the material for the repairing particles 741, in view of a temperature characteristic, a parting property and the like, PFA may preferably be used. As the repairing particles 741, in this embodiment, commercially available PFA particles (“MP-102”, manufactured by Du Point-Mitsui Fluorochemicals Co., Ltd.) were used. The particle size of the repairing particles 741 was about 2-7 μm.

### (8) Repairing Process and Repairing Effect of Surface Layer Damage on Fixing Roller 71

FIG. 7 is a schematic view of the fixing roller 71 and the sliding device 73 as seen from an upstream side of the feeding direction of the recording material P. FIG. 7 shows a state in which the sliding device 73 is pressed in the arrow Al direction by the press springs 79.

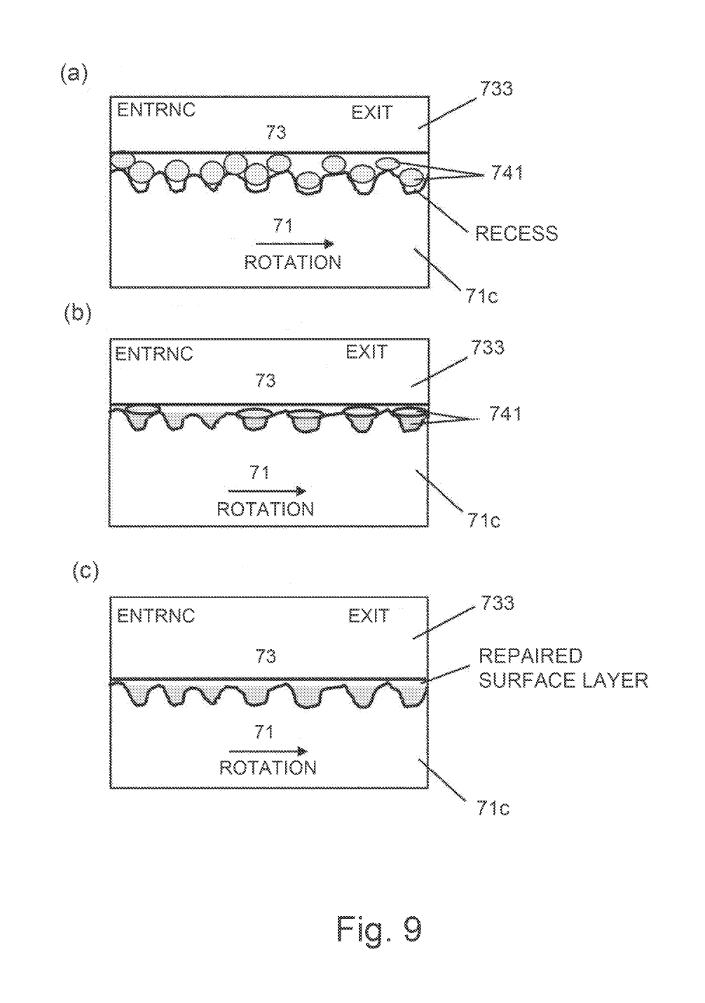

FIG. 8 is a schematic view for illustrating a force received by the surface of the fixing roller 71 in the sliding position N3. In FIG. 8, in order to clearly indicate the position of the sliding position N3, the sliding device 73 is indicated by a broken line.

As shown in FIG. 8, the fixing roller 71 is rotated in the arrow R1 direction in the figure, and therefore the surface of the fixing roller 71 receives a dynamic frictional force Fr directed oppositely to the rotational direction R1. By this dynamic frictional force Fr, frictional heat locally generates between the surfaces of the fixing roller 71 and the film 733, and is conducted to the repairing particle, 741 on the fixing roller 71.

With reference to (a) to (c) of FIG. 9, a process of repairing the surface layer damage of the fixing roller 71 in which the abrasive particles 741 supplied from the supplying device 74 to the fixing roller 71 are welded on the surface of the fixing roller 71 in the sliding position N3 will be described.

In FIG. 9, (a) is a schematic sectional view showing the neighborhood of the sliding position N3 before the repairing of the surface layer damage of the fixing roller 71, and (b) and (c) are schematic sectional views showing the neighborhood the sliding position N3 after a lapse of 1 minute and a lapse of 2 minutes, respectively, from start of the repairing of the surface layer damage of the fixing roller 71.

As shown in (a) of FIG. 9, before the surface layer damage repairing, the repairing particles 741 exist in the sliding position N3, but are not welded on the fixing roller 71.

As shown in (b) of FIG. 9, after the lapse of 1 minute from the start of the surface layer damage repairing, by the dynamic frictional force Fr described above with reference to FIG. 8 and heat and pressure in the sliding position N3, the repairing particles 741 are melted so as to cover the damage of the fixing roller 71 and is extended. In the sliding position N3, the repairing particles 741 are welded on the surface of the fixing roller 71 under application of not only the heat by the ceramic heater 735 and the halogen heater 75 of the fixing roller 71 but also frictional heat by the dynamic frictional force Fr.

Then, as shown in (c) of FIG. 9, after the lapse of two minutes from start of the surface layer damage repairing, the repairing particles 741 substantially cover the surface layer damage of the fixing roller 71, so that the repairing is completed.

As described above, a parting layer of the repairing particles 741 welded on the surface of the fixing roller 71 cover the damage on the fixing roller surface, so that an image defect (stripes or the like caused due to the paper edge damage) on the toner image fixed on the recording material P becomes invisible. Even when the parting layer of the repairing particles 741 cannot completely cover the entirety of the damage on the surface of the fixing roller 71 to the extent that the damage becomes invisible, if the parting layer can cover the damage to some extent, an effect that the damage on the toner image fixed on the recording material becomes invisible is achieved.

As described above, in order to obtain such an effect that the repairing particles 741 are welded and extended so as to cover the damage on the surface of the fixing roller 71, the dynamic frictional force exerted on the fixing roller surface in the sliding position N3 is needed to some extent.

First, as the dynamic frictional force exerted on the surface of the fixing roller 71 is generated, as described above in this embodiment, the dynamic frictional force Fr generates by sliding between the fixing roller 71 and the film 733. In general, the dynamic frictional force is constant independently of speed, and is proportional to a normal load, and therefore the dynamic frictional force Fr is not influenced by the surface moving speed of the fixing roller 71 but is influenced by a contact pressure (bearing stress) peak value in the sliding position N3.

In this embodiment, the contact pressure peak value in the sliding position N3 is 0.25 MPa. In order to obtain the dynamic frictional force Fr for effectively welding the repairing particles 741 deposited on the surface of the fixing roller 71, the contact pressure peak value in the sliding position N3 may preferably be 0.1 MPa or more.

A repairing time of the damage on the surface of the fixing roller 71 is influenced by the surface moving speed of the fixing roller 71 during the repairing. With a higher surface moving speed of the fixing roller 71, a sliding are per unit time between the fixing roller 71 and the film 733 more increased, and therefore the repairing time becomes shorter. However, when the surface moving speed of the fixing roller 71 is made excessively high, in the sliding position N3, such a defect that the repairing particles 741 positioned on the surface of the fixing roller 71 are scattered from the surface of the fixing roller 71.

From the above, the surface moving speed of the fixing roller 71 may preferably be about 50-500 mm/sec. In this embodiment, the fixing roller 71 is rotated at the surface moving speed of 230 mm/sec.

As described above, the surface damage portion of the fixing roller 71 generated by the edge portions of the recording material is transferred onto the fixing image on the recording material during the image fixing. Particularly, in the case where the glossy paper requiring glossiness is used as the recording material, the toner is sufficiently melted in order to ensure the glossiness, and therefore a continuous minute damage portion on the surface of the fixing roller 71 is liable to be transferred onto the fixing image, so that there is a tendency that uneven glossiness generates on the fixing image and thus an image stripe is liable to become conspicuous.

A relationship between a difference ΔRz in surface roughness of the fixing roller 71 and the image stripe due to uneven glossiness of the fixing image was checked. A surface roughness Rz was measured by a “Micromap” manufactured by Ryoka Systems Inc. The difference ΔRz in surface roughness of the fixing roller 71 was measured at several points while changing a longitudinal position of the fixing roller 71, and was obtained from a maximum difference between maximum and minimum values measured.

As a result, when the surface roughness difference ΔRz of the fixing roller 71 was about 0.7 μm or more, on not only the glossy paper but also the plain paper, the image stripe was visible depending on a print ratio of the image in some cases. When ΔRz was 0.3 μm or less, on both of the glossy paper and the plain paper, the image stripe was not conspicuous even when the toner image is fixed. Therefore, in order to make the image stripe due to the uneven glossiness invisible on the fixing image, there is a need to suppress the surface roughness difference ΔRz to 0.3 μm or less.

In the printer in which the fixing device 7 in this embodiment was mounted, a continuous printing durability test was conducted, and states when the operation in the repairing mode was performed and was not performed were compared. The operation in the repairing mode was performed for two minutes per once every continuous printing of about 500 sheets.

In the continuous printing durability test, 100,000 sheets of the same-sized plain paper was subjected to printing of an image of 5% print ratio, and the damage of the fixing roller 71 was checked during the durability test. The check of the damage of the fixing roller 71 was made by measurement of a depth of the damage by a surface roughness meter and by the presence or absence of the image stripe on toner images with 17 gradation levels by using glossy paper and plain paper which had sizes wider than a width of the paper used in the continuous printing.

When the operation in the repairing mode was not performed, at the time of printing of 1,000 sheets, the fixing roller surface roughness difference ΔRz became larger than 0.3 μm due to the paper edges, and the image stripe was observed on the glossy paper. Further, at the time of printing of 10,000 sheets, ΔRz reached 0.7 μm or more, and the image stripe generated on not only the glossy paper but also the plain paper.

However, when the operation the repairing mode was performed, the repairing particles 741 are welded and extended so as to cover continuous minute damage generated on the fixing roller 71 by the paper edge portion. For that reason, by the above-described repairing effect, even when the printing was continued up to 100,000 sheets, ΔRz was able to be suppressed to 0.3 μm or less. For that reason, the image stripe was not generated on not only the glossy paper but also the plain paper.

According to the fixing roller 7 in this embodiment, the repairing particles 741 are supplied from the supplying device 74 to the sliding position N3 by the rotation of the fixing roller 71. The repairing particles 741 are extended by the friction between the film 733 and the fixing roller 71 in the sliding position N3 so as to cover the damage on the surface of the fixing roller 71 and then is welded on the fixing roller surface, so that the fixing roller surface damage is repaired.

As a result, such a functional effect that it is possible to suppress generation of the image defect due to the uneven glossiness resulting from the paper edge portion damage generated on the fixing roller surface while suppressing shortening of a durable lifetime of the fixing roller 71 is achieved.

### Embodiment 2

Another embodiment of the fixing device 7 will be described. In the fixing device 7 in this embodiment, members and portions similar to those in the fixing device 7 in Embodiment 1 are represented by the same reference numerals or symbols and will be omitted from redundant description.

### (1) Fixing Device 7

The fixing device 7 in this embodiment is characterized in that a function of reciprocating the sliding device 73 relative to the fixing roller 71 in a state in which the sliding position N3 is formed by the sliding device 73 and the fixing roller 71 is added to the fixing device 7 in Embodiment 1.

In the fixing device 7 in this embodiment, in order that the sliding device is constituted so that the sliding device ca be reciprocated in the axial direction of the fixing roller, the holder 730 is provided with a guiding groove (not shown) parallel to the axial direction of the fixing roller, and the plunger for the solenoid SL3 is held slidably in the guiding groove. A length of the guiding groove is longer than a sliding amount W (FIG. 7) described later. That is, the sliding device 73 can move in the axial direction of the fixing roller 71 by a distance equal to the sliding amount W. The axial direction of the fixing roller 71 is a direction crossing the rotational direction R1 of the fixing roller 71.

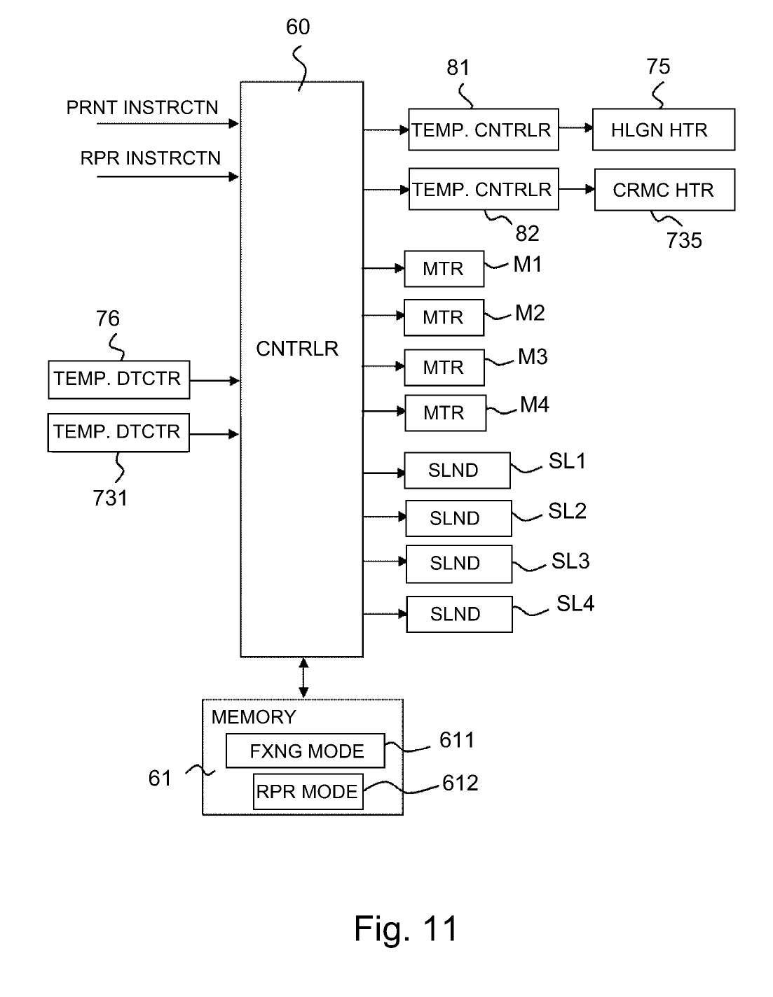

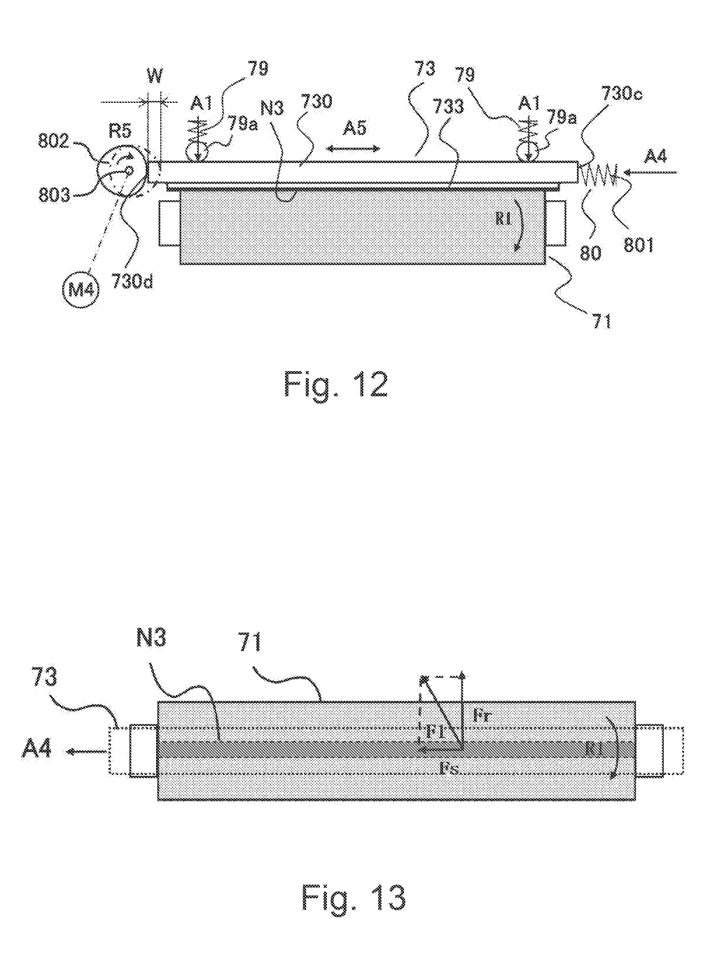

FIG. 11 is a control block diagram of the fixing device 7 in this embodiment. FIG. 12 is a schematic view for illustrating a sliding mechanism (moving mechanism) 80 for reciprocating the sliding device 73 in the axial direction of the fixing roller 71.

As shown in FIG. 12, the sliding mechanism 80 includes a pressing spring 801, a cam 802 and a motor M4. The pressing spring 801 presses one end portion 730c of the holder 730 in an arrow A4 direction in the figure, i.e., the other end portion 730d opposite from the one end portion 730c with respect to the direction perpendicular to the feeding direction a. On the other hand, a cam surface of the cam 802 is contacted to the other (opposite) end portion 730d of the holder 730.

The motor M3 is driven by the controller 60, and the cam 802 is rotated in an arrow R5 direction by rotating a cam shaft 803 of the cam 802 by the motor M4. As a result, the sliding device 73 is reciprocated in an axial direction, of the fixing roller 71, indicated by an arrow A5 direction in the figure. The reciprocating motion of the sliding device 73 is performed in the repairing process in which in the operation in the repairing mode, the repairing particles 741 are welded on the surface of the fixing roller 71 in the sliding position N3 to repair the surface layer particle. In FIG. 12, a roller 70a rolls on the holder 730 with movement of the sliding device 73, a pressing spring 79 presses the holder 730 in the arrow A1 direction via the roller 79a.

The sliding amount W of the sliding device 73 by the rotation of the cam 802 is set at about 1 mm, so that it is possible to obtain an effect of extending the repairing particles 741 at the sliding position N3. However, a large sliding amount W achieves a larger effect. Therefore, in this embodiment, the sliding amount W was 3 mm.

Further, when a period (cycle) of the reciprocating motion of the sliding device 73 overlaps with a rotation period of the fixing roller 71, in the sliding position N3, the film 733 rubs (abrades) the same position (portion) of the fixing roller surface. For that reason, the damage is liable to generate on the surface layer 71c of the fixing roller 71, so that the damage repairing effect is considerably decreased. Accordingly, a period of one reciprocation of the sliding device 73 and the rotation period of the fixing roller 71 are at lease required not to be synchronized with each other. In this embodiment, the rotation period of the fixing roller 71 was about 0.956 sec (the surface moving speed of 230 mm/sec), while the period of the reciprocating motion of the sliding device was 6.00 sec.

FIG. 13 is a schematic view for illustrating a force received by the surface of the fixing roller 71 in the sliding position N3. In FIG. 8, in order to clearly indicate the position of the sliding position N3, the sliding device 73 is indicated by a broken line.

As shown in FIG. 13, the fixing roller 71 is rotated in the arrow R1 direction in the figure, and therefore as the dynamic frictional force Fr directed oppositely to the fixing roller rotational direction R1 is exerted on the repairing particles 741 deposited on the surface of the fixing roller 71 in the sliding position N3. Further, the sliding device 73 is reciprocated in the axial direction of the fixing roller 71, and therefore a dynamic frictional force Fs of the reciprocating motion is exerted on the fixing roller surface. In FIG. 13, the dynamic frictional force Fs exerted on the surface of the fixing roller 71 during movement of the sliding device 73 in the arrow A4 direction in the figure was shown. As the resultant of the above-described two dynamic frictional forces Fr and Fs, the surface of the fixing roller 71 in the sliding position N3 receives a dynamic frictional force F1.

### (2) Repairing Process and Repairing Effected of Surface Layer Damage on Fixing Roller 71

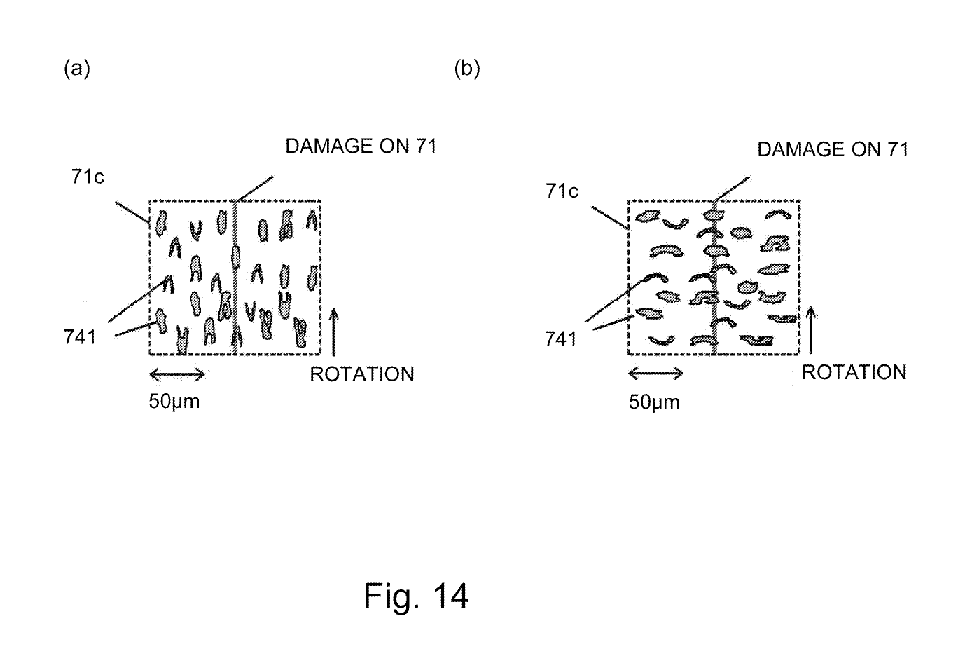

In FIG. 14, (a) is a schematic view of the surface of the fixing roller 71 when the paper edge damage repairing is performed by the method described in Embodiment 1. In Embodiment 1, the fixing roller 71 and the film 733 slide with each other only in the fixing roller rotational direction. In this case, as shown in (a) of FIG. 14, when the damage extends in the circumferential direction of the fixing roller 61, the repairing particles 741 welded on the surface layer 71c of the fixing roller 71 is extended only in the rotational direction of the fixing roller 71 by the dynamic frictional force Fr exerted on the surface of the fixing roller 71. For that reason, the damage with respect to the circumferential direction of the fixing roller 71 is repaired only by the repairing particles 741 supplied to the position of the damage.

On the other hand, in FIG. 14, (b) is a schematic view of the surface of the fixing roller 71 when the paper edge damage repairing is performed by the method in this embodiment.

In this embodiment, as described above, the sliding device 73 is reciprocated in the axial direction of the fixing roller 71, and therefore the frictional force exerted from the film 733 on the surface of the fixing roller 71 can have a longitudinal component of the fixing roller 71 in addition to the component with respect to the rotational direction of the fixing roller 71. Accordingly, as shown in (b) of FIG. 14, the repairing particles 741 welded on the surface layer 71c of the fixing roller 71 is extended not only in the rotational direction of the fixing roller 71 but also in the longitudinal direction of the fixing roller 71. For that reason, not only the repairing particles 741 supplied to the position of the damage but also the repairing particles 741 supplied to the neighborhood of the damage cover the damage, so that the damage can be repaired. Compared with the case of Embodiment 1, these damage is interrupted intermittently, and therefore an effect that the damage does not readily appear as vertical stripes on the fixing image can be obtained.

In each of the printer in which the fixing device 7 in Embodiment 1 was mounted and the printer in which the fixing device 7 in this embodiment (Embodiment 2) was mounted, a continuous printing durability test was conducted, and surface layer damage repairing effects on the fixing roller 71 in the operation in the repairing mode in the fixing devices 7 in Embodiments 1 and 2 were compared. The operation in the repairing mode was performed for two minutes per once every continuous printing of about 100 sheets.

In the continuous printing durability test, 1000 sheets of the same-sized thick paper having a basis weight larger than that of the paper used in Embodiment 1 was subjected to printing of an image of 5% print ratio, and then the damage of the fixing roller 71 was checked. The check of the damage of the fixing roller 71 was made by measurement of a depth of the damage by the surface roughness meter and by the presence or absence of the image stripe on toner images with 17 gradation levels by using glossy paper and plain paper which had sizes wider than a width of the paper used in the continuous printing.

With respect to the fixing device 7 in Embodiment 1, at the time of printing of 1000 sheets, the fixing roller surface roughness difference ΔRz became larger than 0.3 μm due to the paper edges, and the image stripe was not observed on the plain paper but was observed on the glossy paper.

However, in this embodiment (Embodiment 2), the repairing particles 741 are welded and extended so as to cover continuous minute damage generated on the fixing roller 71 by the paper edge portion. and therefore, by the above-described repairing effect, even when the printing was continued up to 1000 sheets, ΔRz was able to be suppressed to 0.3 μm or less. For that reason, the image stripe was not generated on not only the plain paper but also the glossy paper.

### Embodiment 3

Another embodiment of the fixing device 7 will be described. In the fixing device 7 in this embodiment, members and portions similar to those in the fixing devices 7 in Embodiments 1 and 2 are represented by the same reference numerals or symbols and will be omitted from redundant description.

### (1) Fixing Device 7

The fixing device 7 in this embodiment is characterized in that the sliding device 73 of the fixing device 7 used in Embodiment 2 is removed and that the damage on the surface of the fixing roller 71 is repaired by sliding the supplying roller 747 of the supplying device 74 and the fixing roller 71 with each other while heating the rollers.

### (2) Repairing Mode 612

The operation in the repairing mode 612 for the direction 7 in this embodiment includes two operations consisting of the supplying operation of the repairing particles 741 and the repairing operation, of the surface layer damage of the fixing roller 71, performed after the supplying operation.

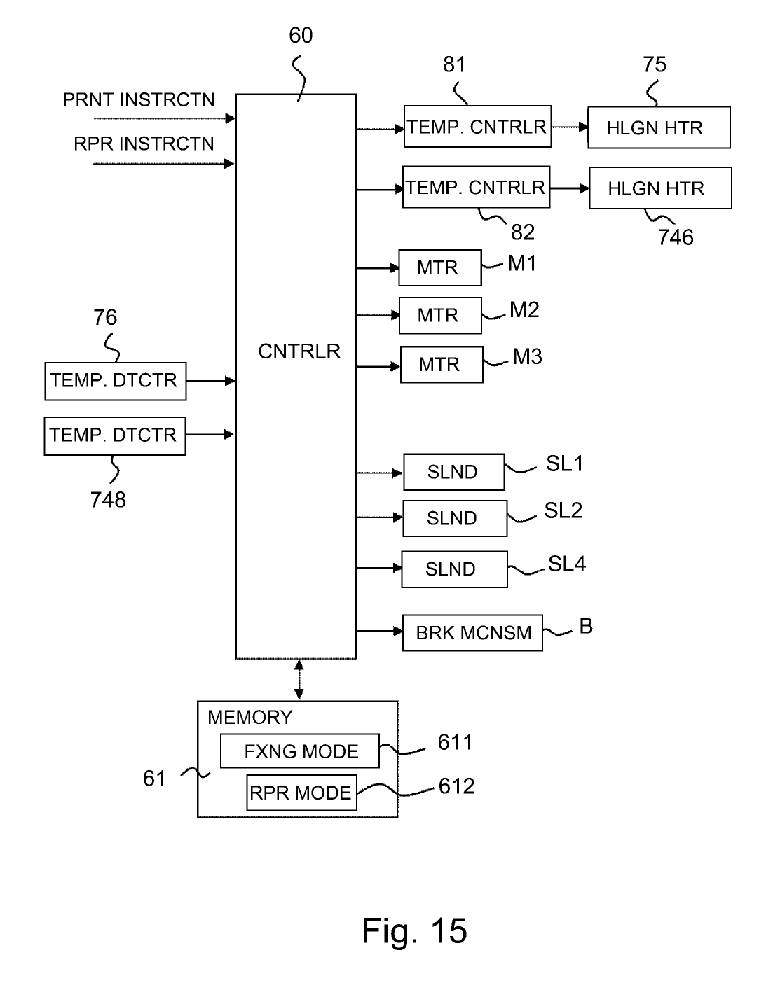

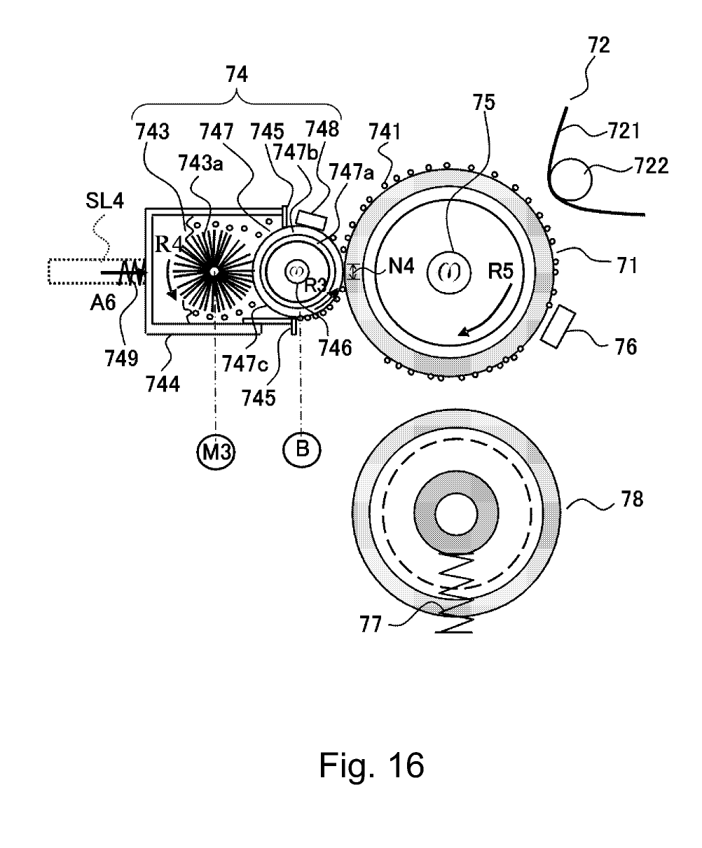

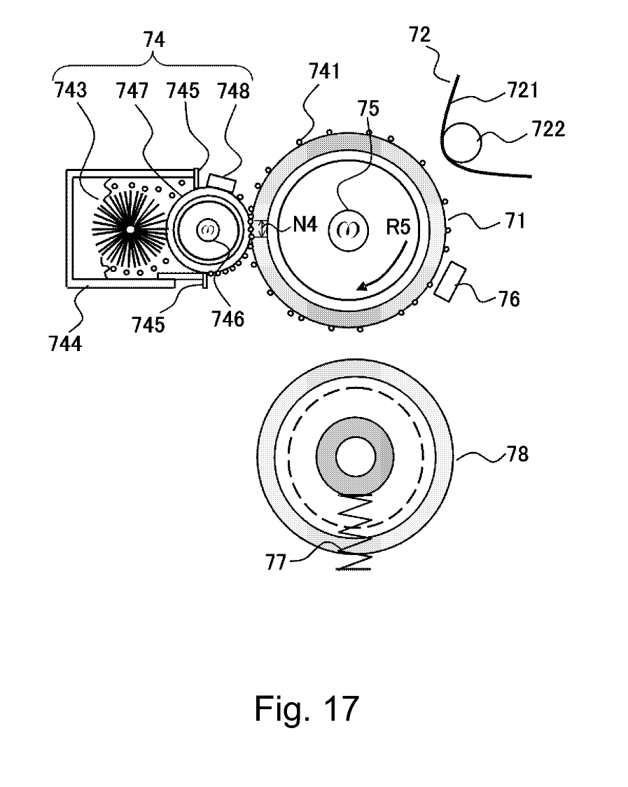

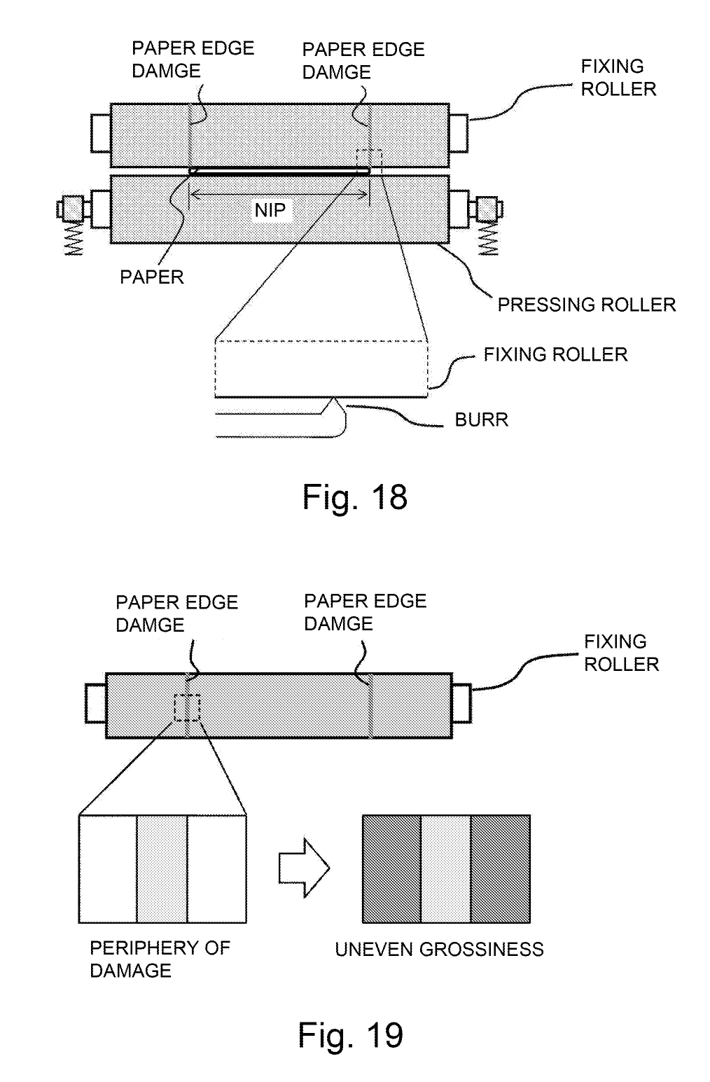

FIG. 15 is a control block diagram of the fixing device 7. FIG. 16 is a schematic sectional view of the fixing device 7 during a supplying operation of the repairing particles 741 in the operation in the repairing mode. FIG. 17 is a schematic sectional view of the fixing device 7 during a repairing operation of the surface layer damage of the fixing roller 71 in the operation in the repairing mode.

During the supplying operation of the repairing particles 741, in order to maintain the repairing particles 741 on the surface of the fixing roller 71, by the controller 60, solenoids SL1 and SL2 are driven (turned on). As a result, the pressing roller 78 and the cleaning device 72 are spaced from the surface of the fixing roller 71 (FIG. 16).

As shown in FIG. 16, in the supplying device 74, the brush roller 743 is rotated in the arrow R4 direction at the surface moving speed of 100 mm/sec by the motor M3 driven by the controller 60. By rotation of the brush roller 143, the repairing particles 741 in the accommodating container 744 are supplied to the surface of the supplying roller 747. As a result, the repairing particles 741 are uniformly deposited on the surface of the supplying roller 747, and the supplying roller 747 holds the repairing particles 741.

Further, by driving (turning off) the solenoid SL4 by the controller 60, the supplying rubbing portion N4 is formed by the surface of the supplying roller 747 and the surface of the fixing roller 71. The supplying roller 747 is rotated in the arrow R3 direction by following the rotation of the fixing roller 71, so that the repairing particles 741 on the surface of the supplying roller 747 are supplied to the surface of the fixing roller 71 through the supplying portion N4. The repairing particles 741 supplied to the surface of the fixing roller 71 are fed from the supplying portion N4 to the original supplying portion by the rotation of the fixing roller 71, and are accumulated at the supplying portion between the fixing roller 71 and the supplying roller 747.

During the repairing operation of the surface of the fixing roller 71, as shown in FIG. 17, rotation of the brush roller 743 and the supplying roller 747 of the supplying device 74 is stopped, and then the surfaces of the supplying roller and the fixing roller 71 are slid with each other, so that the surface layer damage of the fixing roller 71 is repaired.

The controller 60 steps drive of the motor M3 (FIGS. 15 and 16) in order to stop the rotation of the brush roller 743. Further, the controller 60 drives a brake mechanism (brake means) B (FIGS. 15 and 16) such as an electromagnetic brake in order to stop the rotation of the supplying roller 747.

The supplying roller 747 in this embodiment is shown in FIG. 16, formed by molding, on the surface of a hollow core metal 747a of aluminum, a 1 mm-thick layer of a silicone rubber having a rubber hardness of 20° (JIS-A hardness under a load of 1 kg) as an elastic layer 747b. Then, on the surface of the elastic layer 747b, as a sliding layer (surface layer) 747c, a 200 μm-thick PFA resin material layer is coated. An outer diameter of the supplying roller 747 is 30 mm.

The sliding layer 747c is provided for reducing a frictional force generated due to friction with the surface of the fixing roller 71. As a material for the rubbing roller 747, a fluorine-containing resin material such as not only PFA excellent in sliding property but also PTFE, FEP or the like may preferably be used.

Further, the supplying roller 747 includes a halogen heater (heating source) 746 provided inside the hollow core metal 747a, and is temperature-controlled by the second temperature control circuit 82 and a temperature detecting element 748 such as a thermistor disposed in non-contact with the supplying roller surface. The supplying roller 747 is pressed against the surface of the fixing roller 71 at the pressure of 39.2 N (4 kgf) by the pressing spring 749, so that the supplying portion N4 is formed by the surface of the supplying roller 747 and the fixing roller 71.

The controller 60 obtains the temperature detected by the temperature detecting element 76, and controls the electric power supplied from a power source (not shown) to the halogen heater 75 by driving the image temperature control circuit 81 on the basis of the detection temperature. Further, the controller 60 obtains a detection temperature of the surface of the rubbing roller 747 monitored by the temperature detecting element 748, and controls the electric power supplied from the power source to the halogen heater 746 by driving the second temperature control circuit 82 on the basis of the detection temperature.

Also in the operation in the repairing mode, similarly as in Embodiment 1, setting is made so that the surface moving speed of the fixing roller 71 is 230 mm/sec and the surface temperatures of the fixing roller 71 and the rubbing roller 747 are 180° C.

The repairing particles 741 accumulated in the supplying portion N4 are melted under application of heat of the fixing roller 71 heated by the halogen heater 75 and heat of the rubbing roller 747 heated by the halogen heater 746, an then is welded on the surface of the fixing roller 71 under application of the pressure in the supplying portion N4. As a result, the damage on the surface of the fixing roller 71 is repaired.

During the damage repairing operation on the surface of the fixing roller 71 in the operation in the repairing mode 612, by using the sliding mechanism 80 described in Embodiment 2, the supplying device 74 may also be reciprocated in the axial direction of the fixing roller 71. By this reciprocating motion of the supplying device 74, in the supplying portion N4, the repairing particles 741 on the supplying roller 741 are extended so as to cover the damage on the surface of the fixing roller 71 and is welded on the fixing roller surface, so that the damage on the fixing roller surface is repaired. Therefore, also in the fixing device 7 in this embodiment, a functional effect similar to that of the fixing device 7 in Embodiment 2.

In the fixing device 7 in Embodiment 1, the supply of the repairing particles 741 and the damage repairing on the surface of the fixing roller 71 were performed simultaneously. In the fixing device 7 in this embodiment, the supply of the repairing particles 741 and the damage repairing on the surface of the fixing roller 71 are performed separately. For this reason, compared with the fixing device 7 in Embodiment 1, a time necessary to repair the damage on the surface of the fixing roller 71 becomes long. However, there is no need to use the sliding device 73, and therefore the direction 7 in this embodiment has an advantage in terms of a cost and size of the entirety of the fixing device 7 compared with the fixing device 7 in Embodiment 1. That is, the fixing device 7 in this embodiment has such an advantage that the fixing device 7 in this embodiment can be prepared in expensively and downsized compared with the fixing device 7 in Embodiment 1.

### Other Embodiments

In the fixing devices 7 in Embodiment 2, the constitution in which the fixing roller 71 is fixed and the sliding device 73 was reciprocated was described. In contrast thereto, a constitution in which the sliding device 73 is fixed and the fixing roller 71 is reciprocated may also be employed. Alternatively, a constitution in which both of the sliding device 73 and the fixing roller 71 are reciprocated in opposite directions may also be employed.

That is, a constitution in which the fixing roller 71 and the sliding device 73 are moved relative to each other may also be employed. As a constitution for reciprocating the fixing roller 71, the sliding mechanism 80, consisting of the cam 802 and the pressing spring 801 in combination, described in Embodiment 2 can be used.

In the fixing devices 7 in Embodiments 1 and 2, a constitution in which a heater (heating source) is disposed inside the core metal 78a of the pressing roller 78 and in which the surface of the pressing roller 78 is rubbed with the film 733 of the sliding device 73 while heating the pressing roller 78 by the heater may also be employed. As a result, it is possible to repair the damage generated on the pressing roller surface.

Further, a constitution in which the surface of the fixing roller 71 is rubbed with the film 733 of the sliding device 73 and in which the surface of the pressing roller 78 is rubbed with a film of another sliding device (not shown) having the same structure as that of the sliding device 73 may also be employed. As a result, it is possible to repair the damage generated on the fixing roller surface and the damage generated on the pressing roller surface. That is, a constitution in which at least one member of the fixing roller 71 and the pressing roller 78 is rubbed with the film of the sliding device may be employed.

In the fixing device 7 in Embodiment 3, the constitution in which the fixing roller 71 is fixed and the supplying device 74 was reciprocated was described. In contrast thereto, a constitution in which the supplying device 74 is fixed and the fixing roller 71 is reciprocated may also be employed. Alternatively, a constitution in which both of the supplying device 74 and the fixing roller 71 are reciprocated in opposite directions may also be employed. That is, a constitution in which the fixing roller 71 and the supplying device 74 are moved relative to each other may also be employed. As a constitution for reciprocating the fixing roller 71, the sliding mechanism 80 described in Embodiment 1 can be used.

In the fixing device 7 in Embodiment 3, a constitution in which a heater (heating source) is disposed inside the core metal 78a of the pressing roller 78 and in which the surface of the pressing roller 78 is rubbed with the supplying roller 747 of the supplying device 74 while heating the pressing roller 78 by the heater may also be employed. As a result, it is possible to repair the damage generated on the pressing roller surface.

Further, a constitution in which the surface of the fixing roller 71 is rubbed with the supplying roller 747 of the supplying device 74 and in which the surface of the pressing roller 78 is rubbed with a supplying roller of another supplying device (not shown) having the same structure as that of the supplying device 74 may also be employed. As a result, it is possible to repair the damage generated on the fixing roller surface and the damage generated on the pressing roller surface.

That is, a constitution in which at least one member of the fixing roller 71 and the pressing roller 78 is rubbed with the supplying roller of the supplying device may be employed.

In Embodiments 1 to 3, as a contact-and-separation mechanism (means) for moving the pressing roller 78, the cleaning device 72, the sliding device 73 and the supplying device 74 toward and away from the fixing roller 71, the solenoids SL1, SL2, SL3 and SL4 are used. However, the contact-and-separation mechanism is not limited to the solenoids, but may also be a cam mechanism including a motor and a cam.

The image heating apparatus according to the present invention is not limited to use as the fixing devices 7 as in Embodiments 1 to 3. The image heating apparatus can also be effectively used as an apparatus (device) for modifying glossiness of an image (fixed image) once fixed on the recording material or a temporarily fixed image (partly fixed image).

While the invention has been described with reference to the structures disclosed herein, it is not confined to the details set forth and this application is intended to cover such modifications or changes as may come within the purpose of the improvements or the scope of the following claims.

This application claims the benefit of Japanese Patent Application No. 2014-076241 filed on Apr. 2, 2014, which is hereby incorporated by reference herein in its entirety.

What is claimed is:

1. An image heating apparatus comprising:
a rotatable member configured to form a nip for heating an image on a recording material, wherein said rotatable member including a fluorine-containing resin material layer at a surface thereof;
a rubbing member configured to rub a surface of said rotatable member in a rubbing position; and
a supplying mechanism configured to supply fluorine-containing resin material particles to the rubbing position.

2. An image heating apparatus according to claim 1, wherein the fluorine-containing resin material particles are formed of the same fluorine-containing resin material as that for the fluorine-containing resin material layer.

3. An image heating apparatus according to claim 1, wherein said supplying mechanism includes a container configured to accommodate the fluorine-containing resin material particles and a supplying member configured to supply the fluorine-containing resin material particles to the rubbing position.

4. An image heating apparatus according to claim 1, wherein said supplying mechanism includes a container configured to accommodate the fluorine-containing resin material particles, and the fluorine-containing resin material particles accommodated in said container are supplied to the rubbing position by being supplied to said rubbing member.

5. An image heating apparatus according to claim 1, further comprising a moving mechanism configured to move at least one of said rotatable member and said rubbing member so that in a contact state between said rotatable member and said recording material member, said rotatable member and said rubbing member are moved relative to each other in a direction crossing a rotational direction of said rotatable member.
